(19) United States
(12) Patent Application Publication
(10) Pub. No.: US 2012/0013706 A1
(43) Pub. Date: Jan. 19, 2012

(54) INFRARED WIDE FIELD IMAGING SYSTEM INTEGRATED IN A VACUUM HOUSING

(75) Inventors: Guillaume Druart, Buc (FR); Jérôme Primot, Chatillon (FR); Nicolas Guerineau, Antony (FR); Jean Taboury, Sceaux (FR)

(73) Assignees: Entre National de la Recherche Scientifique-CNRS, Paris Cedex 16 (FR); ONERA (Office National d'Etudes et Recherches Aer, Chatillon (FR)

(21) Appl. No.: 13/121,327

(22) PCT Filed: Oct. 7, 2009
(86) PCT No.: PCT/FR2009/001189

§ 371 Date: Aug. 25, 2011

(30) Foreign Application Priority Data
Oct. 7, 2008 (FR) 08/05528

(51) Int. Cl. H04N 7/00

(52) U.S. Cl. 348/36; 348/E05.024

(57) ABSTRACT

The present disclosure relates to a compact wide field imaging system for the infrared spectrum range, the system including a vacuum housing with a porthole, a cooled dark room arranged inside the vacuum housing and provided with an opening referred to as a cold diaphragm, an infrared detector arranged inside the cooled dark room, and a device for the optical conjugation of the field rays with the detector. In the system, the optical conjugation device does not include any element located outside the vacuum housing, and includes at least one cold lens located inside the cooled dark room, the pupil of the optical conjugation device coinciding with the cold diaphragm.

### CROSS-REFERENCE TO RELATED APPLICATIONS

This application is a National Phase Entry of International Application No. PCT/FR 2009/001189, filed on Oct. 7, 2009, which claims priority to French Patent Application Serial No. 08/05528, filed on Oct. 7, 2008, both of which are incorporated by reference herein.

### TECHNICAL FIELD

The present invention relates to an infrared wide field imaging system integrated within a vacuum housing comprising a cooled detector and a dark room.

The present invention relates to the field of imaging in the infrared spectrum range. More particularly, it relates to a field ray imaging system in the infrared spectral range comprising an infrared detector, a device for optically conjugating the field rays with the detector and a dark room integrating said detector. In the present patent document, “field rays” means all rays originating from an infinite scene and crossing the center of the input pupil.

### BACKGROUND

Such a system is to be used for wide field imaging, typically in a field of view between 20° and 180°, in an infrared spectrum band, for driving or guiding missions. Currently, in this technical field, the needs relates to the miniaturization of imaging systems. In this regard, it is important to have less and less bulky systems, so as to facilitate their integration in more complex systems. Further, these systems must exhibit sufficiently high spatial resolution and sensitivity. Finally, it is necessary that these systems exhibit a sufficient S/N ratio to detect a target at a given temperature over a background with a different temperature.

In this regard, it is known from the prior art to use a cooled detector and to integrate it within a cold screen called “dark room” hereafter, opened by a so-called cold diaphragm. The role of this diaphragm is to limit the background flux seen by the detector and thus limits the angle under which the detector sees the exterior scene. This diaphragm is also called opening diaphragm and defines the limits of the solid angle of the useful beam emitted by a reference point of the object or source. Conventionally, it is located on the optical axis of the system. This dark room, cooled at a very low temperature (typically, at −200° C.) is positioned within a cryostat, hereafter called vacuum housing, closed by a porthole. The vacuum created within the housing provides a thermal insulation between the dark room containing the detector and the housing walls at room temperature, thus avoiding any risk of rime in the vicinity of the detector.

It is known from the prior art that the design of an infrared camera requires:
The reduction of irradiation due to the camera environment by decreasing the aperture of the cold diaphragm, and
The maximization of the flux emitted by the points of the scene to be observed by increasing the aperture of the optical conjugating device pupil, called “objective”. In fact, and by definition, the pupil of an objective is described by an aperture of a certain diameter within a privileged plane delimiting the width of a ray beam from a point of the scene. The image of this aperture by the objective is called output pupil.

To this end, the designer of the objective will seek to make the objective output pupil coincide with the cold diaphragm. In this case, the objective is called “cold pupil” objective. Cold pupil objectives known in the prior art consist in placing the conjugating optical elements outside the dark room and whose output pupil coincide with the cold diaphragm.

Such a solution is described in U.S. Pat. No. 4,783,593. In this document, the infrared detector is positioned in a cryogenic environment. To allow the focalization of the field rays with a sufficient resolution, a pair of telecentric lenses are used, one of which being located within the cryogenic environment, behind the cold diaphragm. This pair refocuses the image provided by a first lens disposed in front of the rest of the system, making it possible to form a high quality image on the detector, while ensuring the coincidence between the output pupil and the cold diaphragm.

Another solution is described in U.S. Pat. No. 7,002,154. In this document, the imaging system comprises a plurality of non cooled optical elements, disposed along the optical axis between the system input pupil and an insulating window, as well as a plurality of reflecting annular segments disposed around the optical axis between the input pupil and the insulating window. Among the optical elements, at least one is disposed between the diaphragm and one of the reflecting segments positioned against the insulating window.

Nevertheless, the drawback of these solutions is that they are very bulky. Indeed, these cold pupil type solutions require a system for conjugating the pupil with the cold diaphragm, which adds more optical elements to the system. Moreover, insofar as they are used for high performance applications (be it in terms of field, angular resolution and range), they require a big aperture both in the optical axis and the field, a constraint involving the correction of numerous aberrations. Consequently, suitable diopters—lenses—are added in order to maintain the imaging system at the diffraction limit. In these conditions, it clearly appears that the number of optics to add will be even larger the larger the system aperture is.

A solution aimed at reducing the number of lenses is described in Korean patent document KR 1999/065839. In this document, a telecentric, compact optical system is composed of a diaphragm, an aspheric lens and a pass-band optical filter. An object is imaged on a sensor positioned after the optical system. The diaphragm is disposed so as to face the object to be imaged, its position being adjustable by a user. The aspheric lens is positioned at a given distance from the diaphragm. This lens has a convex shape and a positive refractive index. On its rear face it has a diffractive area to converge rays incident on the lens towards the image by refraction and diffraction while correcting the chromatic aberrations. The pass-band filter is disposed between the rear face of the aspheric lens and the sensor. The implementation of this diffractive area at the aspheric lens makes it possible to reduce the number of required lenses.

Nevertheless, this solution has the disadvantage of implementing a diffractive area to compensate the chromatism of the optical system as well as a pass-band optical filter, resulting in a further significant cost and production difficulty. Further, this solution is only described for an application in the visible light range and not in the infrared one. Thus, it contains no dark room and the diaphragm being used is not a cold diaphragm.

Thus, related art solutions do not provide an infrared imaging system which is at the same time simple, miniature, wide field, of high resolution, while conjugating the pupil with the system cold diaphragm.

### SUMMARY

The aim of the present invention is to remedy to this technical problem by directly integrating the optical conjugating device inside the vacuum housing of which pupil coincides with the cold diaphragm. This coincidence makes it possible to obtain a cold pupil objective with no pupil conjugation, thus simplifying the optical combination with equivalent performances.

The optical combination assembly is integrated within the vacuum housing. This integration makes it possible to make the assembly compact and to extend the field of use of the camera to severe use conditions which will not influence the optical and radiometric quality of the camera. More particularly, the propagation medium transmission will not depend on the ambient air hygrometry and the infrared materials of the optical elements will keep their features over time, even though these are hygroscopic.

The approach of the solution would be to study different existing optical designs, in particular, “optics free” imaging systems, such as a pinhole. The drawback of the latter is usually that of having a low optical aperture, which makes it inadequate for low flux applications. The pinhole being very much closed and field tolerant, it yet appeared that the integration thereof within a wide field system, generally composed of a first field compression lens and of a series of lenses for field focalization and correction, makes it possible to eliminate all lenses expect the first field compression lens.

To this end, the object of the invention is a compact, wide field imaging system for the infrared spectrum range, comprising a vacuum housing including a porthole, a cooled dark room located within the vacuum housing, provided with an aperture called cold diaphragm, an infrared detector located within the cooled dark room and an optical conjugating device for conjugating the field rays with the detector. In this system, the optical conjugating device does not include any element positioned outside the vacuum housing and comprises at least a cold lens located inside the cooled dark room, the pupil of the optical conjugating device coinciding with the cold diaphragm. Preferably, the optical conjugating device is composed of a single lens.

The lens used has a function of focusing and diverting the field rays. It makes it possible to correct the aberrations in the infrared spectrum band used. Herein, the lens having a size larger than the diaphragm, which functions as a cold diaphragm, the latter functioning as an input pupil for the system and helps distributing the field beams over different areas of the lens which makes it possible to locally and separately correct the aberrations of different fields by means of a selection of the surface curvatures of the lens.

Thus, this imaging system, including the combination of the lens and the diaphragm, makes it possible to easily and effectively correct the off-screen aberration as only one lens is required, this lens further having conventional dimensions, and thus can be produced easily and at low cost. This system has also conventional architectures, requiring the use of a combination of a plurality of lenses to obtain such a correction, which considerably increases both the encumbrance and the cost of the system. Moreover, this system is very much tolerant with regard to the positioning of the lens and the diaphragm, which makes it optically and mechanically very robust.

Furthermore, the integration of the lens within the dark room makes it possible to eliminate the problem of conjugating the input pupil and the cold diaphragm, as the implemented cold diaphragm constitutes the optical system input pupil. Finally, it will be appreciated by the man skilled in the art that this system is even more compact the bigger the field to be observed is, which makes it particularly well adapted to wide field view applications.

Advantageously, the surface of one of the diopters of the lens is planar. Thus, the manufacturing of the lens is simplified thanks to the flatness of the surface of one of the diopters, only the shape of the other remaining to be determined. Advantageously, the lens is aspheric, which makes it possible to correct even more finely the field aberrations thanks to the aspheric feature of the lens. In this latter case, the surface of at least one of the diopters of the lens is advantageously conical. The aspherization of the lens is then simplified thanks to the use of a conical surface of simple implementation.

Preferably, the surface of the lens diopter oriented towards the field rays has a curvature radius higher than the surface of the diopter oriented towards the detector. This makes it possible to compress the field rays, as the refraction of the field rays traversing the plane diopter compresses the field angles before they traverse the second diopter.

In an embodiment for minimizing the aberrations based on the infrared spectrum, the surfaces of the diopter lens are calculated so as to correct the system optical aberrations in the infrared spectrum range. In an embodiment for allowing the use of the entire surface of the detector and therefore improving the system resolution, the lens has dimensions substantially equal to that of the detector. In an embodiment for allowing the use of the entire surface of the lens to carry out the correction of the aberrations and thus correct them more precisely, the dimensions of the diaphragm are selected so as to distribute the field rays over the entire surface of the lens.

In an advantageous embodiment for obtaining a telecentric effect for all the field rays, the diaphragm is positioned at a distance of the lens substantially equal to the lens focal distance. Therefore, each field ray is perpendicularly incident (at an angle of substantially 90°) on the detector. This effect is even more important that the system operates in the infrared range for which filters are commonly used. Indeed, as all the field rays arriving perpendicularly on the detectors they will all see the filter in the same “color”.

Advantageously, the diaphragm is positioned at a wall of the dark room. On one hand, this makes it possible to hold the entire system in the dark room and, on the other hand, to reduce the dimensions of the room to the minimum.

Preferably, the refractive index of the lens is higher than 3.0. The use of materials with high refractive index for the lens contributes to improve the system performances. Such materials are not very dispersive, limiting the chromaticity aberrations. This also makes it possible to reduce the curvature radius of the lens and thus to make a thinner lens that could be manufactured more easily.

To perform the various filtrations required to reduce the infrared spectrum range used, for instance, the infrared band II or III, at least one filter is positioned between the detector and the lens. This arrangement is even more advantageous in the case of a telecentric system. According to a particular embodiment, the diopter surface of lens oriented towards the field rays is disposed against the diaphragm. This arrangement is obtained as a metal mask is disposed on the lens diopter, this mask comprising an aperture (circular or rectangular) at its center.

Advantageously, the imaging system of the invention also comprises a cooling device for cooling the interior of the dark room. Hereafter, only the case of cooled detectors will be considered. The vacuum housing porthole may be replaced by a compression lens for compressing the field rays so as to allow the system to reach the ultra wide field (typically, 180° C.). Also, the porthole may be replaced by a lens aimed at correcting the optical aberrations, particularly, the distortion aberration requiring an optical conjugating device which is symmetrical with respect to the diaphragm plane.

In order to increase the system aperture, and thus increase its sensitivity while maintaining a satisfactory modulation transfer function, it may be possible:
to dispose a diverging lens between the infrared detector and the optical conjugating device, and/or
that the front surface of the infrared detector exhibits a non null curvature,
to add an aspherized retardation plate positioned between the porthole or the lens replacing it and the cold lens.

### BRIEF DESCRIPTION OF THE DRAWINGS

The invention will be better understood upon reading the following detailed description of non limiting exemplary embodiments, reference being made to the accompanying figures respectively illustrating:

FIG. 1 a diagram of an infrared wide field imaging system according to a first embodiment of the invention;

FIG. 2 a diagram of a telecentric, infrared wide field imaging system, according to a second embodiment f the invention;

FIG. 3 a diagram of an infrared wide field imaging system provided with a filter, according to a third embodiment of the invention;

FIG. 4 a diagram of an infrared wide field imaging system according to a fourth embodiment of the invention;

FIG. 5 a diagram of an infrared wide field imaging system according to a fifth embodiment of the invention;

FIG. 6 a diagram of an infrared wide field imaging system according to a sixth embodiment of the invention; and

FIG. 7 a diagram of an infrared wide field imaging system according to a seventh embodiment of the invention.

### DETAILED DESCRIPTION OF THE PARTICULAR EMBODIMENTS

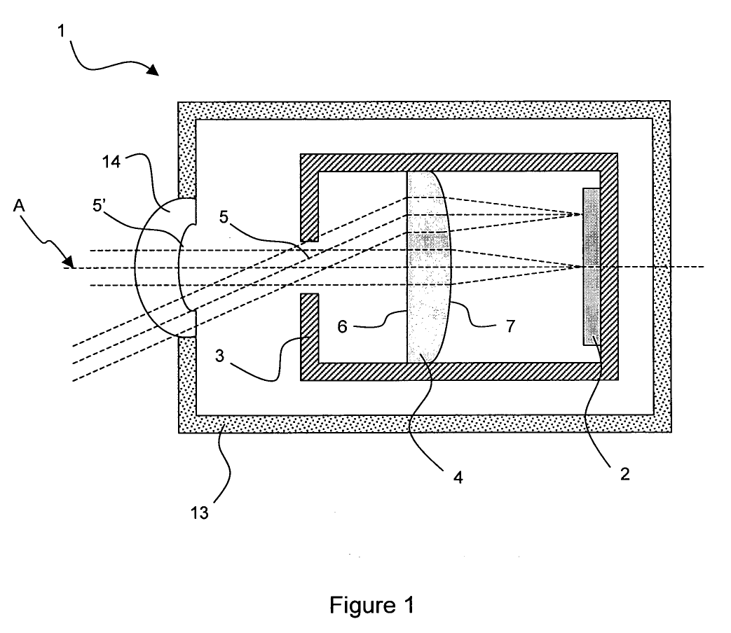

The following exemplary embodiments are applicable to any wide field imaging system, in infrared spectrum bands including spectrum bands II (wavelength between 3 to 5 micrometers) and III (wavelength between 8 and 12 micrometers). FIG. 1 illustrates a diagram of an infrared wide field imaging system according to a first embodiment of the invention.

The imaging system 1 makes it possible to focus a beam of field rays on a detector within an infrared spectrum band. These field rays are from the scene to be imaged. To this end, the system comprises a vacuum housing 13 provided with a porthole 14, a dark room 3, an infrared detector 2, an optical conjugating device 4 as well as a diaphragm 5.

The dark room 3 is cooled by means of a cooling device 13, for example a vacuum housing. This housing has an aperture 5′ in the extension of the dark room aperture 5, along axis A of the imaging system 1. In front of this aperture 5′ a porthole 14 is arranged. Dark room 3 is a temperature-controlled mechanical structure. It has a shape of a black box comprising a single aperture corresponding to diaphragm 5, which, here, has a role of a diaphragm for the dark room. Dark room 3 and diaphragm 5 make it possible to considerably limit the thermal parasitic flux that may distort the measurement in the infrared range.

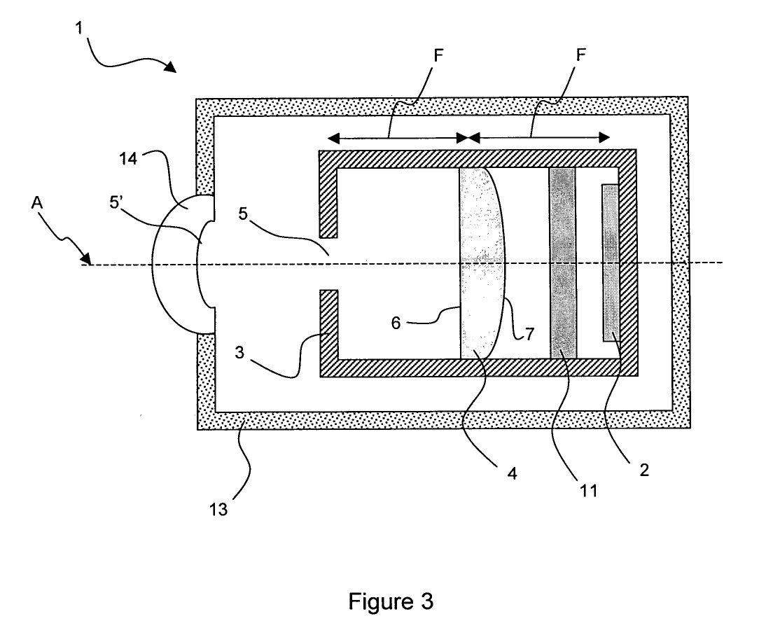

Detector 2 is an infrared sensor. It is been integrated in dark room 3 so as to be joined to the rear face wall of the room. It is composed of a two-dimensional matrix of detection elements. According to another embodiment, the detector is composed of a one-dimensional strip of detection elements. This detector exhibits a high spectrum response in the infrared spectrum band used for the application. This spectrum band may be determined by a pass-band filter disposed between the detector and the aspheric lens 4, such as described hereunder with reference to FIG. 3.

The optical conjugating device 4 makes it possible to optically conjugate the field rays with detector 2. It is composed of an aspheric lens 4 embedded in dark room 3. This lens 4 is located at a distance from detector 2 substantially equal to its focal distance F so as to precisely focus the field rays on the detector.

Lens 4 has a shape of a convex plane lens of which refractive index is positive. In the present exemplary embodiment, the surface of the second diopter 7, oriented towards the detector, is aspheric so as to correct the field aberrations. The surface of the first diopter 6, oriented towards the field rays, is planar. Thus, the industrial manufacturing of this convex plane lens, of which only one surface is to be aspherized, becomes easier.

In another embodiment, lens 4 is not aspheric. It has a convex plane shape, with the second diopter having a spherical surface. With the use of such lens the aberrations are corrected less optimally but it is achieved more easily.

Lens 4 is thus disposed such that the second diopter 7, the surface of which has a non null curvature, is oriented towards the detector 2, with respect to the first diopter 6 the surface of which is planar. This makes it possible to compress for the best the field rays traversing the two diopters of the lens. According to other embodiments, it is possible to achieve a lens 4 such that the surface of both diopters 6, 7 thereof have a non null curvature.

The surface of the second diopter 7 of lens 4 is calculated so as to achieve three functions: diverting the field rays, focusing these field rays and correcting the optical aberrations over the entire field in the desired infrared spectrum range. Lens 4 has dimensions substantially equal to that of detector 2, so as to distribute the field rays over the entire detector surface and thus use the entire detector, making it possible to obtain a better system resolution.

The refractive index of lens 4 is preferably higher than 3.0. For example, the materials used to achieve such a lens may be germanium, of which refractive index is equal to 4.0, or silicon of which refractive index is equal to 3.5. More generally, the lens may be made from any type of material exhibiting a high refractive index. Indeed, this helps improving the system performances, as they limit the chromaticity aberrations owing to their weak chromatic dispersion.

Also, a high refractive index makes it possible to reduce the lens curvature radius and thus, to achieve a thinner lens. In fact, the maximum length of the imaging system is proportional to the refractive index and to the focal distance of the lens. Thus, it appears that the higher the refractive index is the less limitative the size of the system will be.

Diaphragm 5 (cold diaphragm, that is, system pupil) allows for the distribution of the field rays of lens 4. To this end it is positioned in front of this lens 4 and has dimensions lower thereto, so as to be the system input pupil. More precisely, the dimensions of diaphragm 5 are selected based on the optical system aperture α, so as to distribute the field rays over the entire lens surface. Thus, the lens surface is used optimally to correct the aberrations.

This diaphragm 5 is positioned at the dark room 3 wall so as to operate as a dark room cold diaphragm. Therefore, it permits the reduction of the thermal influence of the ambient background by delimiting the view angle of this ambient background. Thus, at the diaphragm the room exhibits its single aperture, the dimensions of which exactly correspond to that of the diaphragm 5. Thus, the entire system may be held in the dark room. All the system elements—dark room, detector, lens and diaphragm—are centered at the optical axis A of the system 1.

A man skilled in the art, owing to his general knowledge in the optical-mechanical field, will readily achieve the design of this system based on the elements described here above. In particular, he will be able to achieve diaphragm 5 by simply perforating a wall of dark room 3, correctly arranging lens 4 for example by means of spacer elements and joining detector 2 over the rear face of the interior of dark chamber 3. This system has the advantage of being compact, compared to designs according to related art, while providing precise measurements over a very wide field of view. Furthermore, it is to be noted that the field limitation of this system is related to the size of the lens and/or to the detector size.

Further, it is also to be noted that the bigger the field viewed by the system the more compact this system is. For example, in the case of a system including a lens of which center thickness is of 2 millimeters, and a detector of which thickness is of 7.5 millimeters, viewing a field of 60°, the encumbrance is equal to 13 millimeters. Meanwhile, a system including the same lens and detector, but viewing a field of 90°, will have an encumbrance of 10 millimeters.

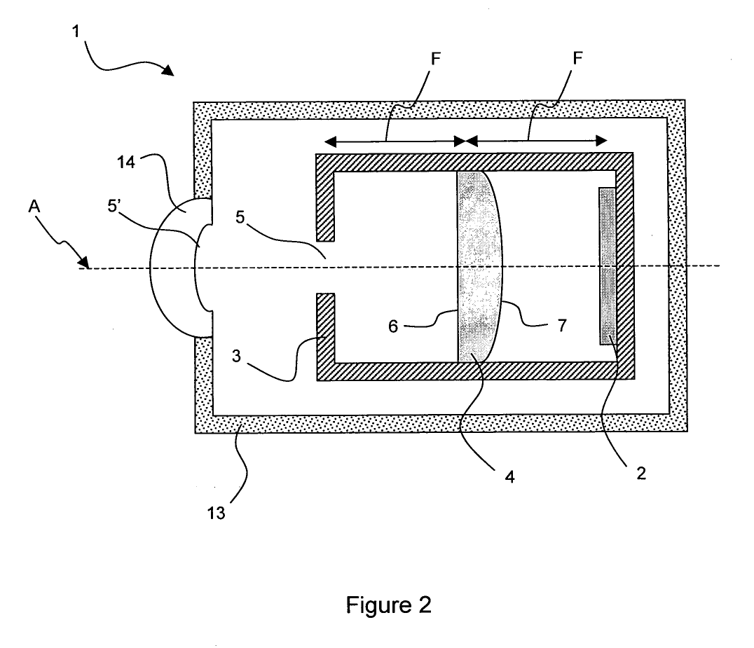

FIG. 2 illustrates a diagram of a telecentric, infrared wide field imaging system, according to a second embodiment of the invention. This imaging system exhibits telecentrism features when diaphragm 5 is appropriately positioned at a preferred position in front of the lens. To this end, diaphragm 5 is positioned in front of the lens 4, at a distance therefrom substantially equal to a focal distance F of lens 4. The telecentric effect obtained for all field rays corresponds to the fact that all main rays, that is, the field rays crossing the input pupil center—diaphragm 5—will arrive at the detector 2 parallely to optical axis A. In order to obtain this preferred position of diaphragm 5, it may be necessary to adjust its position around the position described above owing to the lens thickness and to the large fields used.

FIG. 3 represents a diagram of an infrared wide field imaging system provided with a filter, according to a third embodiment of the invention. A filter 11 is arranged between detector 2 and aspheric lens 4. This filter is disposed in front of detector so as to filter the desired infrared spectrum band. It also makes it possible to correct the problems of cut-off wavelength of the detector, as well as radiometric problems. The skilled person will understand that it is necessary to adjust the positions of the various elements, in particular of lens 4, to compensate the displacement induced by the introduction of the parallel side plate composing a filter.

In this embodiment, the diaphragm is also positioned so as to have a telecentric system. The telecentric feature of the system is particularly fundamental in the infrared range when a filter is used in front of the detector. Indeed, filters used have the feature of filtering according to wavelengths different from rays arriving on the filter with different inclinations. Consequently, with a telecentric system, insofar as all main rays arrive perpendicularly on the filter, they will all see the filter with a same “color”, that is, with the same wavelength.

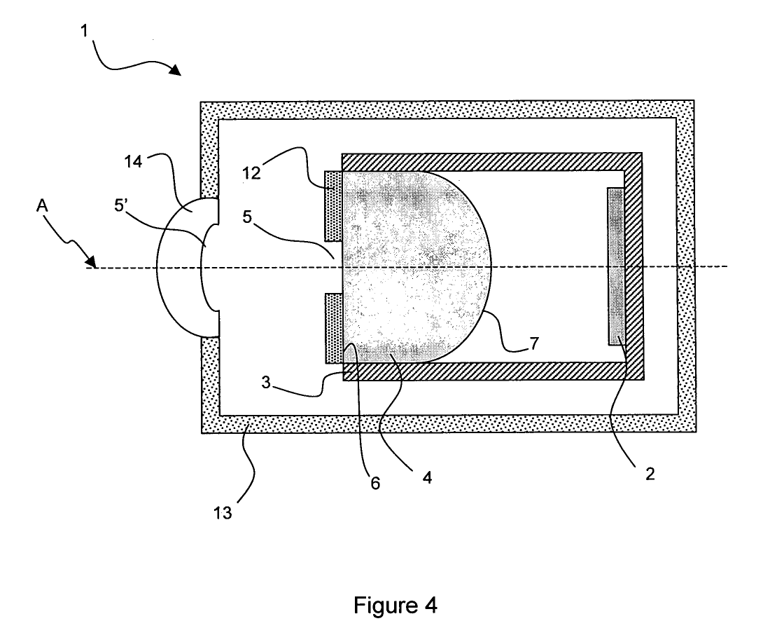

FIG. 4 illustrates a diagram of an infrared wide field imaging system, according to a fourth embodiment of the invention. In this embodiment, lens 4 is a convex plane lens, the plane diopter being diopter 6 oriented towards the field rays. This plane diopter 6 is disposed against diaphragm 5. In order to implement this embodiment, a metal mask 12 is deposited on lens 4 diopter, this mask comprising at its center a circular aperture corresponding to diaphragm 5. Thus, the diaphragm is no longer composed of an aperture in a mechanical piece but of an aperture in a metal mask 12 deposited on lens 4.

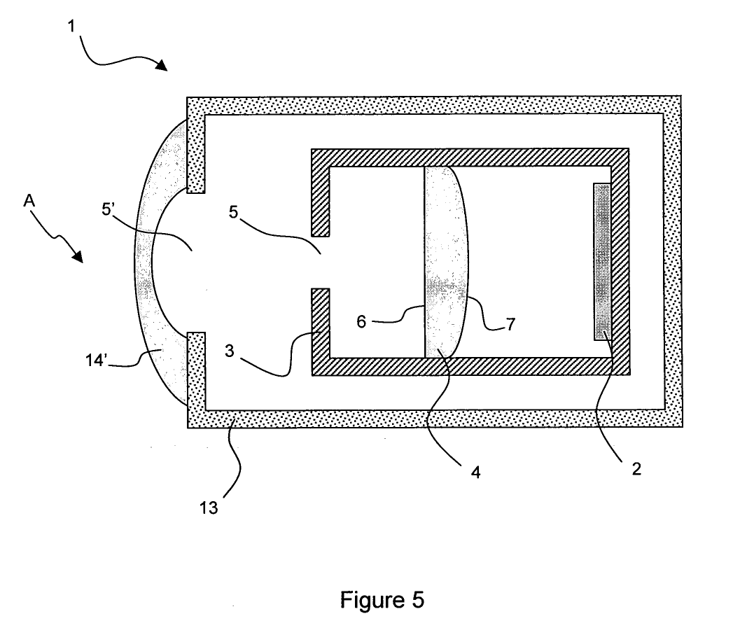

FIG. 5 illustrates a diagram of an infrared wide field imaging system, according to a fifth embodiment of the invention. In this embodiment, porthole 14 is replaced by a field ray compression lens 14′, of which shape is determined so as to compress the field rays and thus to cause rays very much inclined with respect to axis A to reach detector 2. The function of this lens 14 is to convert a very wide field view cone into an observation cone that may be imaged by the integrated lens dark room 3.

Therefore, it allows the imaging system to attain the very wide field range (typically, 180° C.) and thus makes it possible to achieve very wide field, infrared range cameras (called “fish eye”) and which is both very compact and low cost. In the case of a system embedded within a cryostat, such as illustrated in FIG. 5, this lens 14 may advantageously replace the cryostat porthole. In this case, it also has a further function of sealing the cryostat, instead of the porthole which usually plays this role.

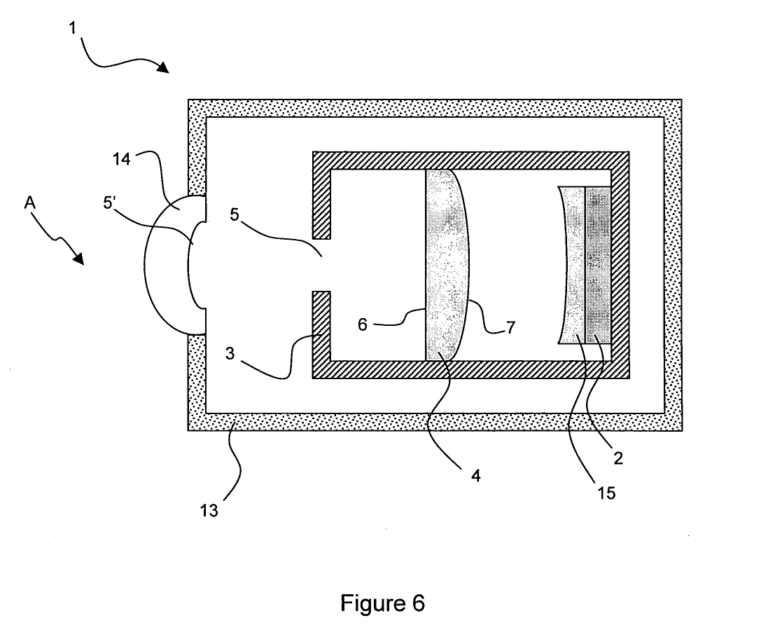

FIG. 6 illustrates a diagram of an infrared wide field imaging system, according to a sixth embodiment of the invention. The progress of this embodiment is found in the integration between lens 4 and detector 2 of a divergent lens 15 allowing the increase of the system 1 aperture, thus its sensitivity, while maintaining a satisfactory modulation transfer function. This lens 15 may be refractive or diffractive. In the case of a configuration using a micro-bolometer, lens 15 may be cleverly integrated instead of the detector porthole.

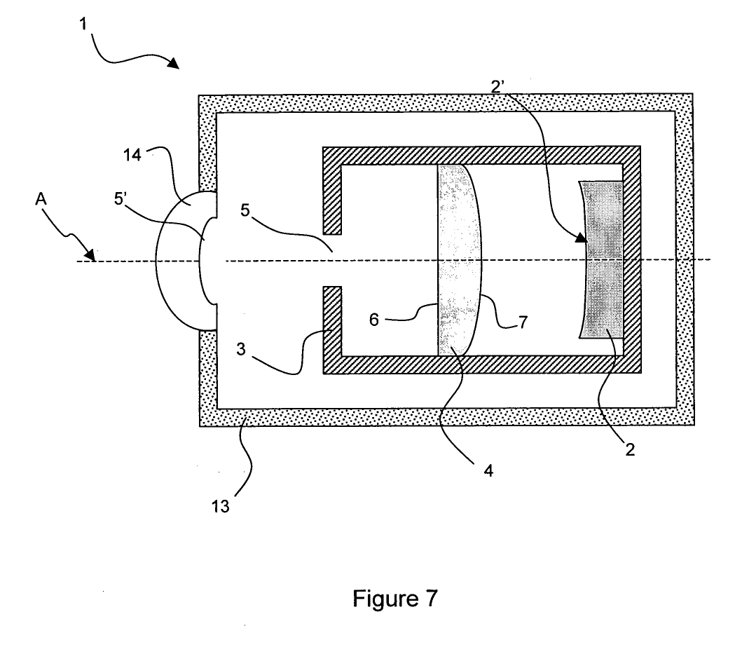

FIG. 7 illustrates a diagram of an infrared wide field imaging system, according to a seventh embodiment of the invention. In this embodiment, the front surface 2′ of the infrared detector 2 exhibits a non null curvature. This curvature of the infrared focal plane makes it possible to increase the system 1 aperture, thus its sensitivity, while maintaining a satisfactory modulation transfer function. In this regard, the front surface 2′ of detector 2 may adopt a spherical shape, an aspherical shape or be composed of a series of small plane detectors of which vertexes rest on a spherical or aspherical structure.

The aforementioned embodiments of the present invention are given by way of example and are in no way limitative. It is understood that a man skilled in the art will readily achieve various alternatives of the invention without departing from the scope of the patent. More particularly, the following modifications may be carried out:
porthole 14 is replaced by a lens correcting the optical aberrations, specifically, the distortion aberration requiring an optical conjugating device 4 which is symmetric with respect to the diaphragm plane, and/or
an aspherized retardation plate is positioned between porthole 14 or the lens replacing it and the cold lens 4.

1. A compact wide field imaging system for the infrared spectrum range comprising a vacuum housing including a porthole, a cooled dark room positioned within the vacuum housing, provided with an aperture called cold diaphragm, an infrared detector positioned within the cooled dark room and an optical conjugating device for optically conjugating the field rays with detector, wherein the optical conjugating device does not include any element arranged outside the vacuum housing and comprises at least a cold lens arranged within said cooled dark room, the optical conjugating device pupil coinciding with the cold diaphragm.

2. The imaging system according to claim 1, wherein the optical conjugating device is composed of a single lens.

3. The imaging system according to claim 1, wherein the surface of one of the diopters of cold lens is planar.

4. The imaging system according to claim 1, wherein the cold lens is aspheric.

5. The imaging system according to claim 4, wherein the surface of at least one of the diopters of cold lens is conical.

6. The imaging system according to claim 1, wherein the surface of diopter of cold lens, oriented towards the field rays, exhibits a radius of curvature higher than the surface of diopter oriented towards detector.

7. The imaging system according to claim 1, wherein the surfaces of diopters of cold lens are calculated so as to correct the optical aberrations of the system in the infrared spectrum range.

8. The imaging system according to claim 1, wherein the cold lens has dimensions substantially equal to that of detector.

9. The imaging system according to claim 1, wherein the dimensions of diaphragm are selected so as to distribute the field rays over the entire surface of lens.

10. The imaging system according to claim 1, wherein the diaphragm is arranged at a distance from lens which is substantially equal to the focal distance of said lens.

11. The imaging system according to claim 1, wherein the diaphragm is positioned at a wall of the dark room.

12. The imaging system according to claim 1, wherein the refractive index of lens is higher than 3.0.

13. The imaging system according to claim 1, wherein at least one filter is disposed between the detector and the lens.

14. The imaging system according to claim 1, wherein the surface of diopter of cold lens, oriented towards the field rays, is positioned against the diaphragm.

15. The imaging system according to claim 1, further comprising a cooling device for cooling the interior of dark room.

16. The imaging system according to claim 1, wherein porthole is replaced by a field ray compression lens.

17. The imaging system according to claim 1, wherein between the optical conjugating device and detector, a divergent lens is arranged.

18. The imaging system according to claim 1, wherein the front surface of detector has a non null curvature.

19. The imaging system according to claim 1, wherein porthole is replaced by a lens for correcting optical aberrations, the distortion aberrations requiring an optical conjugating device which is symmetric with respect to the diaphragm plane.

20. The imaging system according to claim 1, wherein an aspherized retardation plate is arranged between one of: (a) the porthole, and the lens replacing it and cold lens.
